(19) United States
(12) Patent Application Publication
(10) Pub. No.: US 2014/0151298 A1
(43) Pub. Date: Jun. 5, 2014

(54) Method and System for Enhanced Osmotic Mass Transfer

(71) Applicant: James Jeffrey Harris, Cameron Park, CA (US)

(72) Inventor: James Jeffrey Harris, Cameron Park, CA (US)

(21) Appl. No.: 14/096,819

(22) Filed: Dec. 4, 2013

Related U.S. Application Data
(60) Provisional application No. 61/733,208, filed on Dec. 4, 2012.

(51) Int. Cl. B01D 65/02

(52) U.S. Cl. CPC B01D 65/02
USPC 210/636; 210/407

(57) ABSTRACT

A mass transfer process and device are provided that benefits enhanced mass transfer through a membrane as well as maintenance of membrane cleanliness via membrane surface vibration. Uniform amplitude and frequency vibration of the entire membrane in parallel to mass flux reduces internal and external concentration polarization, thereby improving mass flux, especially osmotic driven flux, through the membrane while affording minimal mechanical stress to the membrane. Vibration is provided by piezoelectric imbued membrane support medium wherein vibration is incited by oscillating electric fields generated by electrodes concomitant with the membrane support medium.

### CROSS-REFERENCE TO RELATED APPLICATIONS

This non-provisional patent application claims priority based upon prior U.S. Provisional Patent Application Ser. No. 61/733,208 filed Dec. 4, 2012, in the name of James Jeffrey Harris, entitled “A Vibrating Osmotic Solution Conveyance Process and Device for Enhanced Osmotic Mass Transfer,” the disclosure of which is incorporated herein in its entirety by reference as if fully set forth herein.

### BACKGROUND OF THE INVENTION

The present invention relates generally to mass transfer, and more particularly to mass transfer through a membrane compelled by differing osmotic pressures on opposing sides of the membrane wherein the mass transfer is enhanced by vibratory motion of a membrane supporting medium. The prior art focused on intrinsic membrane and osmotic solution characteristics and macroscopic fluid dynamics in efforts to address performance and challenges associated with osmotic pressure induced mass transfer through membranes. These methods have failed to adequately address the difficult problems associated with concentration polarization effects, fouling and/or scaling. Efforts have been made with hydraulic pressure induced mass transfer to mitigate similar problems through edge supported vibration such as the systems and methods taught in U.S. Pat. No. 6,417,251 B1, U.S. Patent Application No. 2010/0116736 A1, and U.S. Patent Application 2010/0000945 A1. These methods have met with limited success due to both structural failures of the membranes and motion limitations central to the membranes.

The prior art also contains references to acoustically induced vibration for cleaning purposes, such as, for example, those taught in U.S. Pat. No. 4,253,962 and U.S. Patent Application No. 2007/0295674 A1. These methods, although somewhat effective for cleaning, are plagued with non-homogeneous vibration consisting of minimal vibration in some areas and membrane damaging harmonics in other areas.

In particular, the prior art remains challenged by mass transfer rates, scaling, fouling and structural damage to the membranes.

### BRIEF SUMMARY OF THE INVENTION

A mass transfer device and process are provided that facilitate enhanced mass transfer rates through membranes and afford reduction of fouling and scaling propensities of the membranes without burdensome structural failures of the membranes or geometrical constraints associated with membrane configuration.

The membrane mass transfer device is comprised of a membrane separating two fluids of differing osmotic pressure. The membrane is supported by a medium incorporating one or more piezoelectric layers. Mass transfer occurs through this membrane as a consequence of the osmotic pressure differential between the two fluids. Electrical leads and associated electrodes empower electric field generation through the piezoelectric layers embodied in the membrane support medium. In one embodiment, metallic electrodes with associated electric leads encompass both sides of the piezoelectric layers. In another embodiment, one or more electrically conductive fluids, with associated leads, supplant one or both of the metallic electrodes encompassing the piezoelectric imbued membrane support medium. Another embodiment employs one or more transverse permeable spacers providing conveyance space for fluids between the membrane and the membrane support medium. Another embodiment configures the membrane support medium with a textured surface affording fluid flow between the membrane and the membrane support medium. Voltage may be applied to the electrical leads conveying an electric field through the membrane support medium and integral piezoelectric layers. The field suffused piezoelectric layers swell equally and unilaterally as a consequence of the applied electric field, moving the supported membrane in accord. Voltage may then be reduced or eliminated to contract the piezoelectric layers, thereby moving the supported membrane equally and unilaterally in the opposing direction. The voltage may be oscillated to provide vibrating unilateral support of the membrane, compelling uniform membrane vibration.

A process for enhanced mass transfer comprising the steps of conveying fluid in contact with both sides of a membrane wherein the membrane is supported by a membrane support medium comprised of one or more piezoelectric layers encompassed within electric field sources such as metallic electrodes or one or both said fluids being of an electrically conductive nature and operational as an electrode; said electric field sources being provided an oscillating voltage wherein said voltage conveys an oscillating electric field through said piezoelectric layers affording oscillatory swelling and contracting of said piezoelectric layers purveying an oscillatory, vibrating motion to said membrane support medium; said membrane support medium vibration compelling said supported membrane and contacting fluids in oscillating vibration; said vibration reducing external concentration polarization in said contacting fluids adjacent to the membrane; said vibration of the membrane reducing internal concentration polarization within the membrane; reduced external and internal concentration polarization benefitting enhanced mass transfer through said membrane; said vibration further affording solids disengagement and removal thereby benefiting reduction of scaling, fouling and associated maintenance of membrane cleanliness.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cutaway isometric illustration of one embodiment of the present invention wherein two fluids of different osmotic pressures traverse opposing sides of a membrane supported by a flow conducive, surface textured, piezoelectric imbued, membrane support medium;

FIG. 2 is a cutaway isometric illustration of another embodiment of the present invention wherein two fluids of different osmotic pressures traverse opposing sides of a membrane supported by a flow conducive spacer which is supported by a piezoelectric imbued, membrane support medium;

FIG. 3 is a cutaway isometric illustration of another embodiment of the invention wherein two fluids of different osmotic pressures traverse opposing sides of a membrane supported by a flow conducive, surface textured, piezoelectric imbued, membrane support medium;

FIG. 4 is a cutaway isometric illustration of another embodiment of the invention wherein two fluids of different osmotic pressures traverse opposing sides of a membrane;

FIG. 5 is a cutaway isometric illustration of another embodiment of the invention wherein two fluids of different osmotic pressures traverse opposing sides of a membrane; and

FIG. 6 is a cutaway isometric illustration of another embodiment of the invention wherein two fluids of different osmotic pressures traverse opposing sides of a membrane.

### DETAILED DESCRIPTION

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. The present invention will be described with respect to preferred embodiments in a specific context, namely as a device and process for enhancement of osmotic pressure driven mass flow through membranes and as a process and device for maintenance of membrane cleanliness. The invention may also be applied, however, to other situations where enhancement of mass flow is desirable or membrane cleanliness is desired.

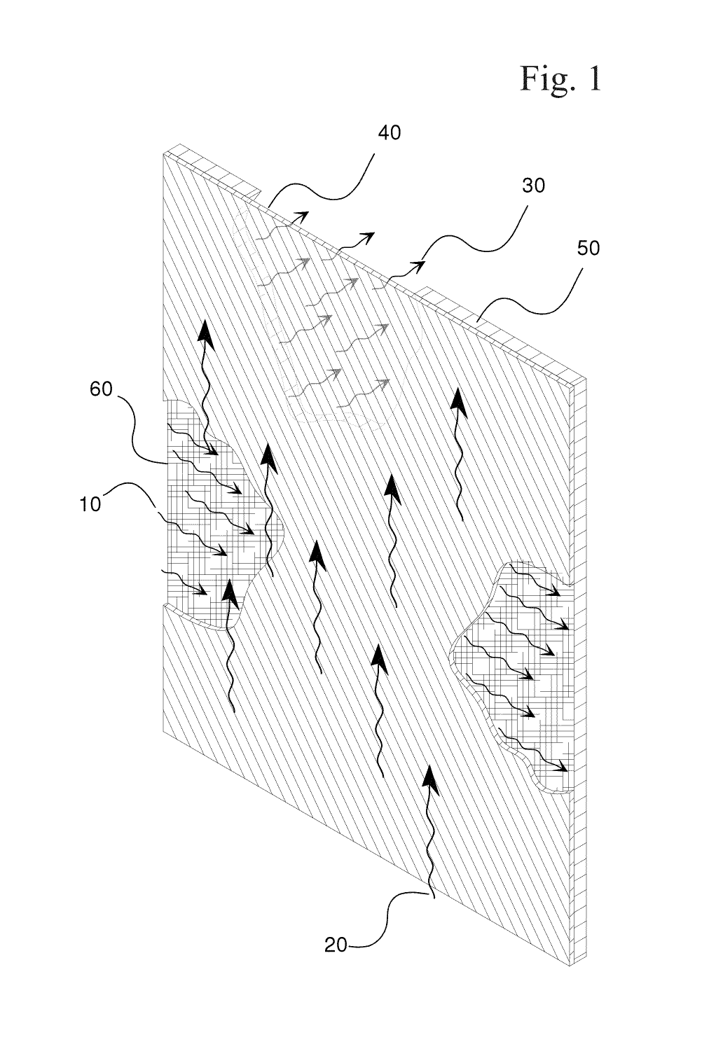

With reference now to FIG. 1, a cutaway isometric view of the present invention is shown. A membrane 40 is supported by a vibrating support medium 50. The vibrating support medium 50 contacts one side of the membrane 40 with flow supporting surface 60. A first fluid 10 conveys upon surface 60 between membrane 40 and the vibrating support medium 50. A second fluid 20 of differing osmotic pressure than first fluid 10 conveys across the membrane 40 opposite the side of first fluid 10. The vibration of vibrating support medium 50 conveys to first fluid 10, membrane 40 and second fluid 20. The provided vibratory motion incites turbulence and fluid shearing at the second fluid 20 and first fluid 10 interfaces with the membrane 40 as well as internal to the membrane 40; reducing internal and external concentration polarization effects, thereby affording enhanced osmotic mass transfer 30 through the membrane 40, between first fluid 10 and second fluid 20.

Liquid mass transfer through the membrane 40 from the second fluid 20 into the first fluid 10 results in concentration of suspended and dissolved solids on the second fluid 20 side of the membrane 40 and dilution on the first fluid 10 side of the membrane. Solids concentration in second fluid 20 may result in solids precipitation as a scale or solids accretion as a foulant on the second fluid 20 side of the membrane 40. Said vibration of the membrane 40, shears and shakes solids from membrane 40, thereby maintaining the cleanliness of membrane 40.

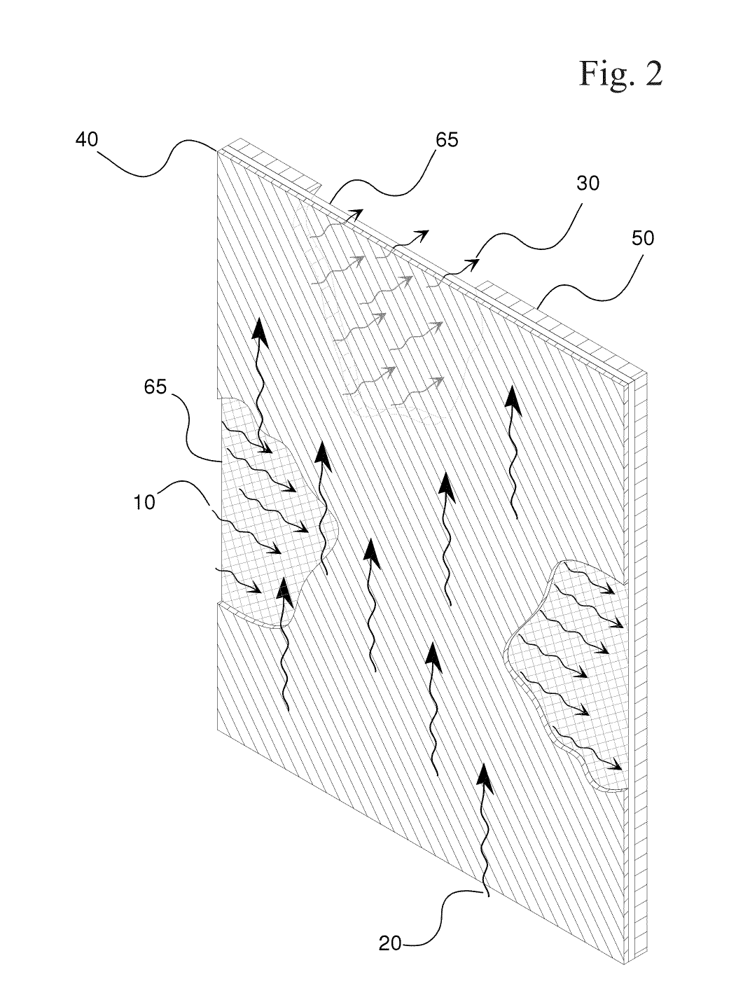

With reference now to FIG. 2, a cutaway isometric view of the present invention is shown. A membrane 40 is supported by a vibrating support medium 50. The vibrating support medium 50 contacts one side of a fluid permeable spacer 65. The opposite side of this spacer 65 contacts membrane 40. A first fluid 10 conveys within the permeable spacer 65 while contacting membrane 40 and the vibrating membrane support medium 50. A second fluid 20 of differing osmotic pressure than first fluid 10 conveys across the membrane 40 opposite the side of first fluid 10. The vibration of vibrating support medium 50 conveys to first fluid 10, the permeable spacer 65, membrane 40 and second fluid 20. The provided vibratory motion incites turbulence and fluid shearing at the second fluid 20 and first fluid 10 interfaces with the membrane 40 as well as internal to the membrane 40; reducing internal and external concentration polarization effects, thereby affording enhanced osmotic mass transfer 30 through the membrane 40, between first fluid 10 and second fluid 20.

As in other embodiments, liquid mass transfer through the membrane 40 from the second fluid 20 into the first fluid 10 results in concentration of suspended and dissolved solids on the second fluid 20 side of the membrane 40 and dilution on the first fluid 10 side of the membrane. Solids concentration in second fluid 20 may result in solids precipitation as a scale or solids accretion as a foulant on the fluid side 20 of the membrane 40. Said vibration of the membrane 40, shears and shakes solids from membrane 40, thereby maintaining the cleanliness of membrane 40.

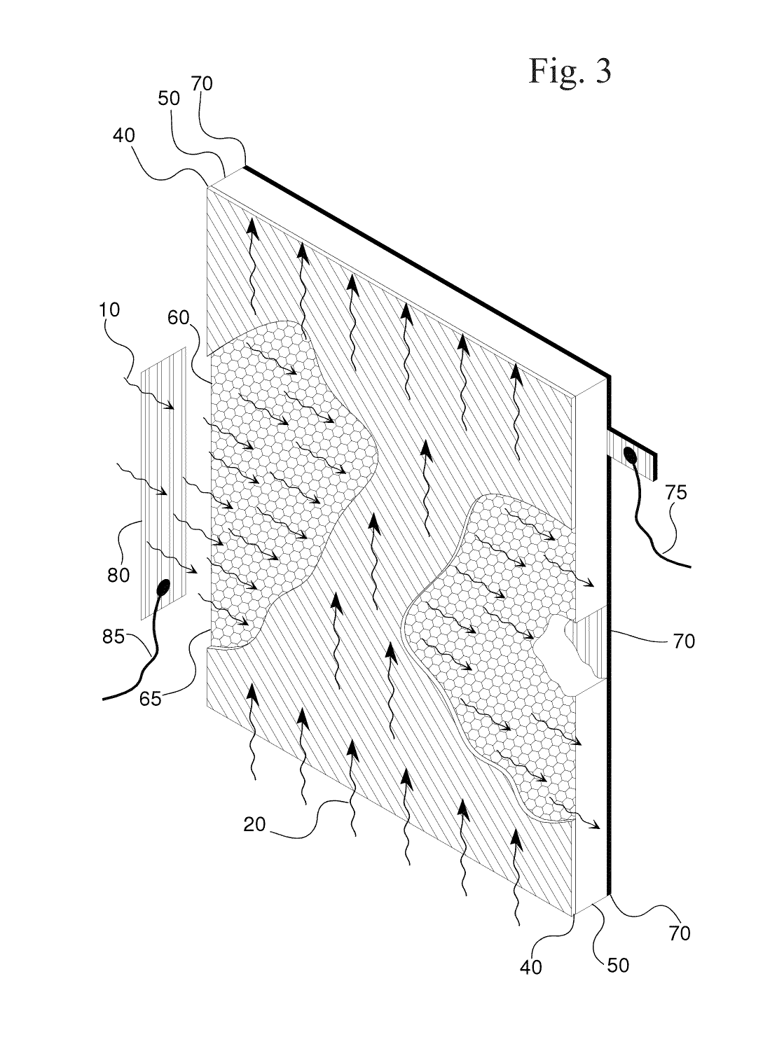

With reference now to FIG. 3, a cutaway isometric view of another embodiment of the present invention is shown. A membrane 40 is supported upon a textured surface 60 of a piezoelectric imbued support medium 50. The textured surface 60 enables flow of an electrically conductive first fluid 10 between the membrane 40 and the membrane support medium 50. An electrode 70 with an associated electric lead 75 occupies the side opposing the textured surface 60 of the piezoelectric imbued membrane support medium 50. The electrically conductive first fluid 10 is in electrical contact with an electrode 80 and associated lead 85. A second fluid 20 of differing osmotic pressure than first fluid 10 conveys across the membrane 40 opposite the side of first fluid 10. In this embodiment of the invention, osmotic pressure differential incites mass flow through the membrane 40 from second fluid 20 into first fluid 10 as first fluid 10 conveys in contact with membrane 50 along textured surface 60. Electrodes 70 and 80 are charged with oscillating voltage applied to leads 75 and 85. Electrically conductive first fluid 10 is voltage energized from contact with electrode 80. Oscillating voltage between energized first fluid 10 and electrode 70 issues an oscillating electric field through the piezoelectric imbued membrane support medium 50. Said oscillating field induces piezoelectric effects of swelling and contracting oscillations within the piezoelectric imbued membrane support medium 50. These oscillations convey vibrational motion to the adjacent first fluid 10, membrane 40 and second fluid 20. The vibration generates shearing and turbulence, enhancing mass conveyance and diffusion rates, providing reduced internal and external concentration polarization impediments within the membrane 40 and the contact regions between the membrane 40 and first fluid 10 and second fluid 20. Internal and external concentration polarization effects are major impediments to osmotic pressure compelled mass transfer to, through and from membranes. The induced vibration of the invention reduces these hindrances thereby enhancing mass transfer between fluids 10 and 20.

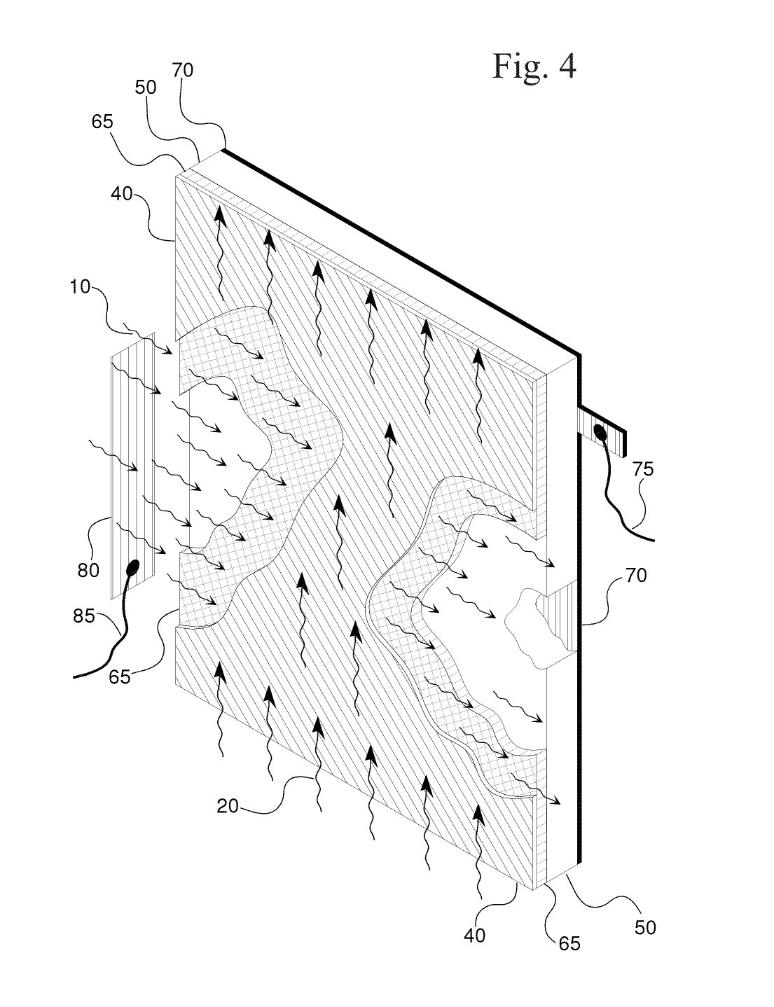

With reference now to FIG. 4, a cutaway isometric view of another embodiment of the present invention is shown. A membrane 40 is supported upon a permeable spacer 65 which is further supported by a piezoelectric imbued support medium 50. The permeable spacer 65 enables flow of an electrically conductive first fluid 10 between the membrane 40 and the membrane support medium 50. An electrode 70 with an associated electric lead 75 occupies the side opposing the textured surface 60 of the piezoelectric imbued membrane support medium 50. The electrically conductive first fluid 10 is in electrical contact with an electrode 80 and associated lead 85. A second fluid 20 of differing osmotic pressure than first fluid 10 conveys across the membrane 40 opposite the side of first fluid 10. In this embodiment of the invention, osmotic pressure differential incites mass flow through the membrane 40 from second fluid 20 into first fluid 10 as first fluid 10 conveys in contact with membrane 50 through permeable spacer 65. Electrodes 70 and 80 are charged with oscillating voltage applied to leads 75 and 85, respectively. Electrically conductive first fluid 10 is voltage energized from contact with electrode 80. Oscillating voltage between energized first fluid 10 and electrode 70 issues an oscillating electric field through the piezoelectric imbued membrane support medium 50. Said oscillating field induces piezoelectric effects of swelling and contracting oscillations within the piezoelectric imbued membrane support medium 50. These oscillations convey vibrational motion to the adjacent, first fluid 10, membrane 40 and second fluid 20. The vibration generates shearing and turbulence, enhancing mass conveyance and diffusion rates, providing reduced internal and external concentration polarization impediments within the membrane 40 and the contact regions between the membrane 40 and first fluid 10 and second fluid 20. Internal and external concentration polarization effects are major impediments to osmotic pressure compelled mass transfer to, through and from membranes. The induced vibration of the invention reduces these hindrances thereby enhancing mass transfer between first fluid 10 and second fluid 20.

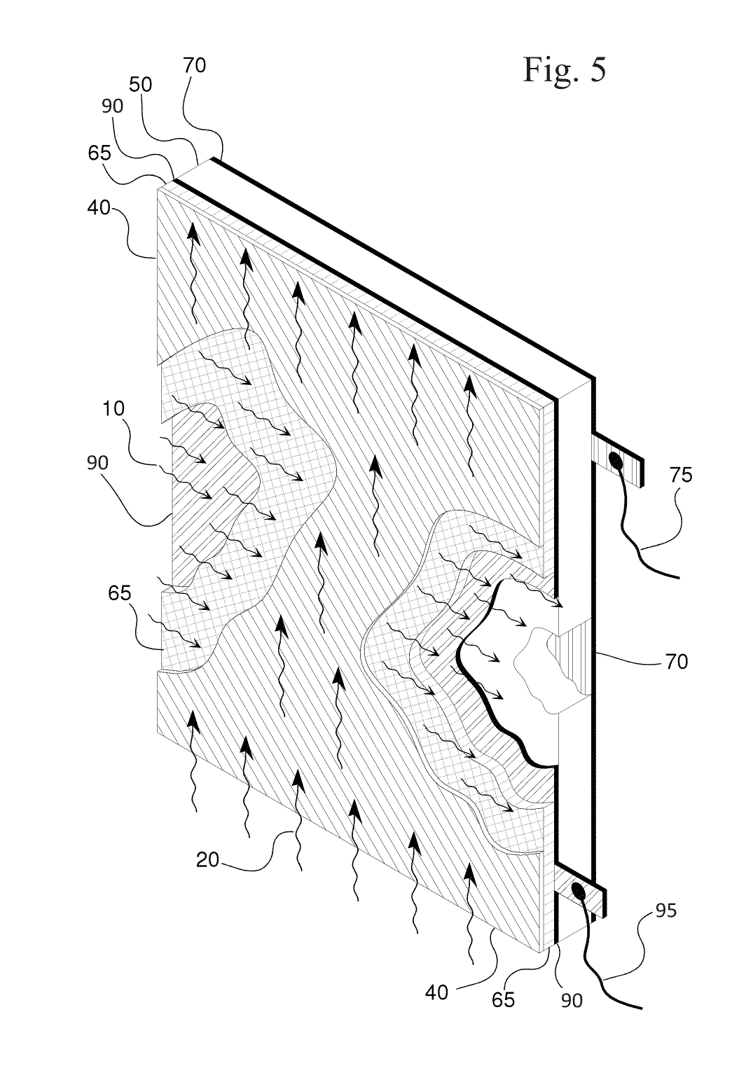

With reference now to FIG. 5, a cutaway isometric view of another embodiment of the present invention is shown. A membrane 40 is supported upon a permeable spacer 65 which is further supported upon an electrode surface 90 with an associated electric lead 95. A piezoelectric imbued support medium 50 is adjacent to electrode 90 on the side opposing permeable spacer 65. An electrode 70 with an associated electric lead 75 occupies the side opposing the electrode 90 side of the piezoelectric imbued membrane support medium 50. Said permeable spacer 65 enables flow of a first fluid 10 between the membrane 40 and the electrode 90. A second fluid 20 of differing osmotic pressure than first fluid 10 conveys across the membrane 40 opposite the side of first fluid 10 and permeable spacer 65.

In this embodiment of the invention, osmotic pressure differential incites mass flow through the membrane 40 from second fluid 20 into first fluid 10 as first fluid 10 conveys in contact with membrane 50 through permeable spacer 65. Electrodes 70 and 90 are charged with oscillating voltage applied to leads 75 and 95. Oscillating voltage between energized electrodes 70 and 90 issues an oscillating electric field through the piezoelectric imbued membrane support medium 50. Said oscillating field induces piezoelectric effects of swelling and contracting oscillations within the piezoelectric imbued membrane support medium 50. These oscillations convey vibrational motion to the adjacent, electrode 90 which further conveys said vibrational motion into permeable spacer 65 and entrained first fluid 10 as well as the permeable spacer supported membrane 50 and second fluid 20. The vibration generates shearing and turbulence, enhancing mass conveyance and diffusion rates, providing reduced internal and external concentration polarization impediments within the membrane 40 and the contact regions between the membrane 40 and fluids 10 and 20, respectively. Internal and external concentration polarization effects are major impediments to osmotic pressure compelled mass transfer to, through and from membranes. The induced vibration of the invention reduces these hindrances thereby enhancing mass transfer between first fluid 10 and second fluid 20.

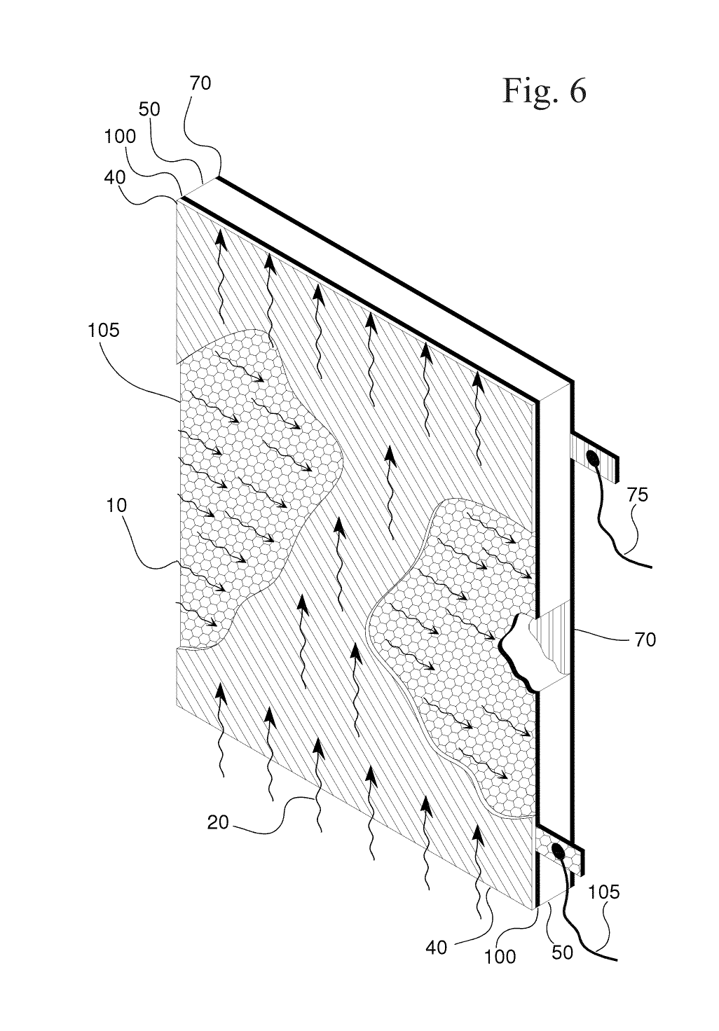

With reference now to FIG. 6, a cutaway isometric view of another embodiment of the present invention is shown. A membrane 40 is supported upon a surface textured electrode 100 with an associated electric lead 105. The surface texture of the electrode 100 enables flow of first fluid 10 between the membrane 40 and the electrode 100. A piezoelectric imbued support medium 50 is adjacent to electrode 100 on the side opposing the textured surface of electrode 100. An electrode 70 with an associated electric lead 75 occupies the side opposing the electrode 100 side of the piezoelectric imbued membrane support medium 50. A second fluid 20 of differing osmotic pressure than fluid 10 conveys across membrane 40 opposite the side of first fluid 10 and the textured surface of electrode 100.

In this embodiment of the invention, osmotic pressure differential incites mass flow through the membrane 40 from second fluid 20 into first fluid 10 as first fluid 10 conveys in contact with membrane 50 along the textured surface of electrode 100. Electrodes 70 and 100 are charged with oscillating voltage applied to leads 75 and 105. Oscillating voltage between energized electrodes 70 and 100 issues an oscillating electric field through the piezoelectric imbued membrane support medium 50. Said oscillating field induces piezoelectric effects of swelling and contracting oscillations within the piezoelectric imbued membrane support medium 50. These oscillations convey vibrational motion to the adjacent, electrode 100 conveying said vibrational motion into first fluid 10, membrane 50 and second fluid 20. The vibration generates shearing and turbulence, enhancing mass conveyance and diffusion rates, providing reduced internal and external concentration polarization impediments within the membrane 40 and the contact regions between the membrane 40 and first 10 and second fluid 20. Internal and external concentration polarization effects are major impediments to osmotic pressure compelled mass transfer to, through and from membranes. The induced vibration of the invention reduces these hindrances thereby enhancing mass transfer between fluids 10 and 20.

There are multiple possible material configurations of the invention. Membranes may be fabricated of one or multiple materials. Cellulose acetate membranes have long been employed for mass transfer processes. Thin film composite membranes, typically comprised of a permeable structural substrate such as polysulfone overlain with an aromatic polyamide or a polyimide rejection layer, are gaining favor. Other types of membrane materials such as polytetraflouroethylene, polyvinylidene-diflouride are being employed in diverse applications. Among other novel aspects, the invention provides substantial benefits to osmotic driven mass transfer using cellulose acetate or thin film composite membranes.

Embodiments of the invention particularly benefit osmotic driven mass transfer processes wherein the osmotic pressure differential between fluids on opposing sides of the membrane compel mass flow through the membrane. Most commonly, the subject fluids are water solutions with different solutes or differing concentrations of solutes. Example of such fluids are freshwater vs. saltwater, freshwater vs. sugar water, seawater vs. heavy brine salt water, freshwater vs. glycol bearing waters, saltwater vs. sugar water as well as multiple combinations such as freshwater vs. a mixture of salt and sugar water. The possible combinations of differing osmotic pressure fluids are numerous.

Osmotic mass transfer rates from fluid to fluid through a membrane rely on diffusion rates and conveyance rates in both the fluids and the membrane. The slowest mass transfer rates occur in quiescent situations with rates limited by diffusion. Quiescence further slows diffusion rates by facilitating development of steady state osmotic pressure gradients (concentration polarization) thereby further depressing mass transfer rates. Vibration of the membrane and fluids establishes a turbulent environment in the fluids and the membrane. Conveyance effects and elimination of osmotic pressure gradients are affected by the bulk motion and continual acceleration imbued by vibration. Conveyance is most beneficial if bulk motion is parallel to the mass transfer direction; accordingly, in certain embodiments, optimal vibration orientation is parallel with mass transfer flux; thereby being perpendicular to the plane of the membrane. In general, vibrational quiescent regions and destructive harmonic regions should not be presented to the membrane. Accordingly, homogeneous vibration oriented perpendicular to the membrane can be advantageous.

One embodiment of a device of the present invention is a vibrating membrane support medium. This medium provides full support coverage of the membrane and vibrates uniformly in frequency and amplitude perpendicular to the plane of the membrane. This plane is more precisely defined as the contact plane of the membrane. As an example, a flat plane membrane will be supported by a flat plane membrane support medium. A curved membrane will be supported by an equally curved membrane support medium. One method of generating vibration in the membrane support medium is the employ of a piezoelectric imbued membrane support medium wherein the medium incorporates one or more layers of piezoelectric material. There are multiple types of piezoelectric materials with poled polyvinylodene-diflouride (PVDF) and ceramic based piezoelectric materials as predominant. In certain embodiments, the preferred peizoelectric material is PVDF because of flexibility and capacity to shape to the membrane support medium shape. This capacity assures the supported membrane will encounter homogeneous vibrational contact. PVDF piezoelectric sheets are available in thicknesses of 28, 40, 52, 64, 110 and 122 microns. Flexibility of PVDF piezoelectric film and vibrational amplitude are inversely related; a 52 micron thickness, for example, provides both acceptable vibrational amplitude as well as adequate flexibility.

Vibration of the piezoelectric imbued membrane support medium requires permeation of the preferred PVDF piezoelectric layers with an oscillating electric field. Such a field requires electrode placement on opposing sides of the PVDF piezoelectric layers. As exemplified in the foregoing discussions, depending upon electrical conductivity of the fluids contacting the membrane, there are generally two primary configurations of electrode placement.

In one configuration, wherein the fluids are not electrically conductive, dielectric coated metallic electrodes are placed on both sides of the PVDF piezoelectric material. In this configuration the preferred method is metallic film deposition on both sides of the PVDF piezoelectric layer. There are two primary methods for providing these metallic films, silver ink and sputtered metallization; in view of flexibility, the use of silver ink metallization can be advantageous.

Another configuration, wherein one of the fluids, preferably the fluid conveyed between the membrane and the piezoelectric imbued membrane support medium, is electrically conductive; the fluid itself may be employed as an electrode. In this configuration a dielectric coated metallic film deposition is only employed on one side of the outermost PVDF piezoelectric electrode films; wherein outermost is defined as the most distant from the electrically conductive fluid. In both configurations piezoelectric vibration is induced in the piezoelectric layers by oscillating the voltage difference between the electrodes on both sides of the piezoelectric layers. In the first configuration, this would entail providing an oscillating voltage differential to the two dielectric metallic films on both sides of the piezoelectric layers, in the second configuration, this would entail applying an oscillating voltage differential to the conducting fluid and the single dielectric coated metallic film electrode.

Typically fluids of high osmotic pressure are electrically conductive. In view of this fact, and in consideration of simplicity, one embodiment of the present invention is conveyance of the fluid with the highest osmotic pressure between the membrane and the piezoelectric imbued membrane support medium; wherein an oscillating voltage differential is applied between this fluid and the single dielectric coated metallic electrode on the outermost side of the piezoelectric layers of the membrane support medium. Where the preferred embodiment, in view of further simplicity and elimination of vibrational suppression by a permeable spacer supporting the membrane; the fluid between the membrane and the piezoelectric imbued membrane support medium is conveyed by a textured surface on the piezoelectric imbued membrane support medium. Where further the preferred embodiment, in view of simplicity as well as safety considerations; the voltage applied to the electrically conductive fluid is continual ground voltage and the oscillating electric field is driven by oscillating voltage as applied only to the metallic film electrode on the outermost most side of the piezoelectric layers.

One novel feature of the present invention is the membrane is driven in vibrational mode not from the edges but rather from the membrane face. This has a decided structural advantage for the membrane. Edge driven vibration stresses the membrane edges to rapid mechanical failure; a problem eliminated with the present invention.

Another novel feature of the present invention is the advantage of employing one of the fluids as an electrode. High osmotic pressure solutions are often electrically conductive. Using this fluid as an electrode affords the employ of only one metallic electrode in piezoelectric excitation. This greatly simplifies and reduces system size, indeed providing the further novel approach of employing efficient and low cost spiral wound membrane elements with vibratory capacity for enhanced performance and cleanliness.

Another novel application for the present invention is the ability to provide crystallization capability to a membrane process without scaling. The self-cleaning vibrations separate crystals precipitating on the membranes affording the novel ability to facilitate membrane crystallization processes without minimal scaling or fouling.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Finally, in the foregoing discussion and in the claims, the terms “including” and “comprising” are used in an open-ended fashion, and thus should be interpreted to mean “including, but not limited to . . . ”.

What is claimed is:

1. A mass transfer device comprising:
a. a membrane having a front portion and a back portion;
b. a vibrating membrane support medium supporting the membrane;
c. a first fluid conveying across the front portion;
d. a second fluid conveying across the back portion;
e. wherein vibrations from the vibrating membrane support medium induce vibrations in the membrane thereby facilitating mass transfer through the membrane and removing foulants from the membrane.

2. The device of claim 1 wherein the first fluid has a different osmotic pressure than the second fluid.

3. The device of claim 1 wherein at least a portion of the membrane support medium comprises a piezoelectric material.

4. The device of claim 1 wherein the back portion is affixed to the membrane support medium and the membrane support medium is textured to facilitate fluid flow.

5. A process for facilitating mass transfer comprising:
a. placing a membrane against a membrane support medium, the membrane support medium having piezoelectric properties and having a textured surface on one side and a non-textured surface on the other side;
b. immersing the membrane support medium in an oscillating electric field to induce vibratory motion of the membrane support medium;
c. conveying a first fluid across one side of the membrane and a second fluid across the other side of the membrane, wherein the first fluid and the second fluid have different osmotic pressures;
d. transferring vibratory motion of the membrane support medium to the membrane, thereby facilitating mass transfer through the membrane and removing foulants from the membrane.

6. The process of claim 5 wherein an electrode is positioned adjacent to the membrane support medium adjacent to the non-textured surface.

7. The process of claim 5 wherein at least one of the first liquid and the second liquid is electrically conductive.

8. The process of claim 5 wherein at least one of the first liquid and the second liquid is electrically conductive and the electrically conductive fluid contacts the electrode when conveyed across the membrane.

9. A process for facilitating mass transfer comprising the steps of:
a. placing a membrane against a membrane support medium, the membrane support medium having piezoelectric properties;
b. conveying a first fluid across one side of the membrane and a second fluid across the other side of the membrane, wherein the first fluid and the second fluid have different osmotic pressures;
c. positioning a first electrode in contact with at least one of the first fluid and the second fluid and positioning a second electrode adjacent to the membrane support medium;
d. applying an oscillating voltage between the first electrode and the second electrode and generating an oscillating electric field permeating the membrane support medium between the conductive fluid and the electrode adjacent to the membrane support medium, thereby causing the membrane support medium to vibrate;
e. wherein the vibration facilitates mass transfer through the membrane and removes foulants from the membrane.

10. The process of claim 9 wherein the first electrode has a fluid flow conducive surface texture upon the membrane side of the electrode.

11. A process for facilitating mass transfer comprising the steps of:
a. positioning a first electrode and a second electrode one side of a membrane and positioning a membrane support medium having piezoelectric properties on the other side of the membrane
b. conveying a first fluid across one side of the membrane and a second fluid across the other side of the membrane, wherein the first fluid and the second fluid have different osmotic pressures;
c. applying an oscillating voltage between the first electrode and the second electrode to generate an oscillating electric field permeating the membrane support medium causing vibration thereof;
d. wherein the vibration facilitates mass transfer through the membrane and removes foulants from the membrane.

12. The process of claim 11 wherein a fluid permeable spacer is positioned between the membrane and the membrane support medium.

13. A process for facilitating mass transfer comprising the steps of:
a. placing a membrane on one side of a spacer and a membrane support medium having piezoelectric properties on the other side of the spacer;
b. immersing the membrane support medium in an oscillating electric field to induce vibratory motion of the membrane support medium;
c. conveying a first fluid across the side of the membrane adjacent to the spacer and a second fluid across the other side of the membrane, wherein the first fluid and the second fluid have different osmotic pressures;
d. vibratory motion of the membrane support medium transfers vibratory motion to the membrane, spacer, first fluid and second fluid thereby resulting in enhanced mass transfer between the fluids through the membrane and the removal of foulants from the membrane.

14. The process of claim 13 wherein an electrode is positioned adjacent to the membrane support medium on the opposite side as the spacer.

15. The process of claim 13 wherein the first fluid is electrically conductive.

16. The process of claim 13 wherein an electrode is positioned adjacent to the membrane support medium on the opposite side as the spacer, wherein the first fluid is electrically conductive, and wherein the first fluid contacts the electrode.

17. A process for facilitating mass transfer comprising the steps of:
a. placing a membrane on one side of a spacer and a membrane support medium having piezoelectric properties on the other side of the spacer
b. conveying a first fluid across one side of the membrane and a second fluid across the other side of the membrane, wherein the first fluid and the second fluid have different osmotic pressures and wherein at least the first fluid is electrically conductive;
c. applying an oscillating voltage between a first electrode contacting the first fluid and a second electrode adjacent to the membrane support medium, the oscillating voltage generating an oscillating electric field permeating the membrane support medium between the first fluid and the second electrode, thereby inducing piezoelectric vibration thereof;
d. the vibratory motion of the membrane support medium transferring vibratory motion to the membrane, first fluid and second fluid resulting in enhanced mass transfer between the fluids through the membrane and assisting in the removal of foulants from the membrane.
